(19) United States
(12) Patent Application Publication
(10) Pub. No.: US 2013/0074519 A1
(43) Pub. Date: Mar. 28, 2013

(54) AUXILIARY POWER UNIT INLET DOOR POSITION CONTROL SYSTEM AND METHOD

(71) Applicants: Timothy Ertz, Scottsdale, AZ (US); Gergory Geyer, Phoenix, AZ (US); Mike Baron, Phoenix, AZ (US)

(72) Inventors: Timothy Ertz, Scottsdale, AZ (US); Gergory Geyer, Phoenix, AZ (US); Mike Baron, Phoenix, AZ (US)

(73) Assignee: HONEYWELL INTERNATIONAL INC., Morristown, NJ (US)

(21) Appl. No.: 13/245,612

(22) Filed: Sep. 26, 2011

(51) Int. Cl. F02C 6/00

(52) U.S. Cl. 60/802

(57) ABSTRACT

Methods and apparatus are provided for controlling an auxiliary power unit (APU) inlet door. A plurality of APU operational parameters and a plurality of aircraft operational parameters are sensed. The APU operational parameters and the aircraft operational parameters are processed to determine a minimum APU inlet door position that will maintain APU turbine inlet temperature at a predetermined value. The APU inlet door is then moved to the determined minimum APU inlet door position.

### TECHNICAL FIELD

The present invention relates to aircraft auxiliary power units (APUs) and, more particularly, to a system and method for controlling the position of an inlet door to an APU.

### BACKGROUND

In many aircraft, the main propulsion engines not only provide propulsion for the aircraft, but may also be used to drive various other rotating components such as, for example, generators, compressors, and pumps, to thereby supply electrical and/or pneumatic power. However, when an aircraft is on the ground, its main engines may not be operating. Moreover, in some instances the main propulsion engines may not be capable of supplying the power needed for propulsion as well as the power to drive these other rotating components. Thus, many aircraft include one or more auxiliary power units (APUs) to supplement the main propulsion engines in providing electrical and/or pneumatic power. An APU may also be used to start the propulsion engines.

An APU is, in most instances, a gas turbine engine that includes a combustion system, a power turbine, a compressor, and an APU controller. During operation of the APU, the compressor draws in ambient air via an inlet door and inlet duct. The compressor compresses the air, and supplies compressed air to the combustion system. The combustion system, under control of the APU controller, receives a flow of fuel from a fuel source and the compressed air from the compressor, and supplies high-energy combusted gas to the power turbine, causing it to rotate. The gas is then exhausted from the APU 100 via an exhaust duct. The power turbine includes a shaft that may be used to drive a generator for supplying electrical power, and to drive its own compressor and/or an external load compressor.

Aircraft original equipment manufacturers (OEMs) and aircraft operators are motivated to reduce fuel burn and emissions from aircraft main propulsion engines and APUs. Historically, fuel burn reduction has been motivated by a desire to reduce operating costs, with reduced emissions being relegated to a secondary consideration. However, current environmental regulations, and the concomitant fees and tariffs associated with certain emission levels, are beginning to contribute to the operating costs of many aircraft operators.

One potential source of undesirably high fuel burn and emissions may be associated with the APU inlet door. In particular, the APU inlet door may be moved to an open position during flight in order to meet certain APU performance levels. In many instances, the control logic associated with the APU inlet door may move the inlet door to a position that is more open than is necessary to sustain actual APU load and/or assure APU stability. This can result in increased drag, and thus increased fuel burn and emissions.

Although the control logic presently implemented in APUs is safe and generally reliable, it does suffer certain drawbacks. For example, the control logic does not control the APU inlet door during in-flight operations to balance APU performance with fuel burn and emissions. The present invention addresses at least this drawback.

### BRIEF SUMMARY

An APU controller is provided that controls the position of the APU inlet door to ensure adequate in-flight APU performance levels, while reducing aircraft drag.

In one embodiment, and by way of example only, an auxiliary power unit (APU) inlet door control system includes an APU controller and an APU inlet door actuator. The APU controller is adapted to receive a plurality of APU signals and a plurality of aircraft signals. Each APU signal is representative of a sensed APU operational parameter, and each aircraft signal is representative of a sensed aircraft operational parameter. The APU controller is configured, in response to the APU signals and the aircraft signals, to determine a minimum APU inlet door position that will maintain APU turbine inlet temperature at a predetermined turbine inlet temperature value, and to supply APU inlet door position commands. The APU inlet door actuator is adapted to couple to an APU inlet door, and is coupled to receive the APU inlet door position commands. The APU inlet door actuation is configured, in response to the APU inlet door position commands, to move to a position representative of the minimum APU inlet door position.

In another exemplary embodiment, an auxiliary power unit (APU) inlet door control system includes an APU controller, an APU inlet door, and an actuator. The APU inlet door is movable to a plurality of positions between a closed position and a maximum open position. The APU controller is adapted to receive a plurality of APU signals and a plurality of aircraft signals. Each APU signal is representative of a sensed APU operational parameter, and each aircraft signal is representative of a sensed aircraft operational parameter. The APU controller is configured, in response to the APU signals and the aircraft signals, to determine a minimum APU inlet door position that will maintain APU turbine inlet temperature at a predetermined value, and to supply APU inlet door position commands. The actuator is coupled to the APU inlet door and is further coupled to receive the APU inlet door position commands. The actuator is configured, in response to the APU inlet door position commands, to move the APU inlet door to the minimum APU inlet door position.

In yet a further exemplary embodiment, a method of controlling an auxiliary power unit (APU) inlet door includes sensing a plurality of APU operational parameters, and sensing a plurality of aircraft operational parameter. The APU operational parameters and the aircraft operational parameters are processed to determine a minimum APU inlet door position that will maintain APU turbine inlet temperature at a predetermined value. The APU inlet door is then moved to the determined minimum APU inlet door position.

Other independent features and advantages of the preferred APU inlet door control system and method will become apparent from the following detailed description, taken in conjunction with the accompanying drawings which illustrate, by way of example, the principles of the invention.

### BRIEF DESCRIPTION OF THE DRAWINGS

FIG. 1 depicts a simplified cross section view of an exemplary embodiment of an auxiliary power unit (APU) coupled to an APU controller; and

FIG. 2 depicts an exemplary process, in flowchart form, that the APU controller depicted in FIG. 1 may implement.

### DETAILED DESCRIPTION OF A PREFERRED EMBODIMENT

The following detailed description is merely exemplary in nature and is not intended to limit the invention or the application and uses of the invention. Furthermore, there is no intention to be bound by any theory presented in the preceding background or the following detailed description.

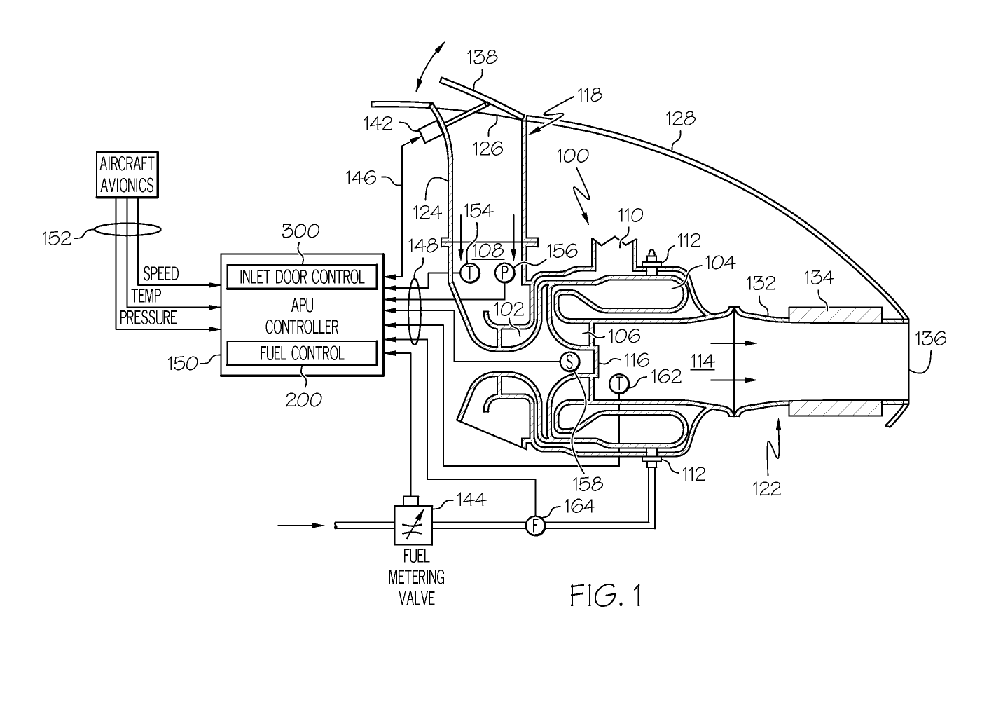

Turning first to FIG. 1, a simplified cross section view of an exemplary embodiment of an auxiliary power unit (APU) is shown. The APU 100 includes a compressor 102, a combustor 104, and a turbine 106. Air is directed into the compressor 102 via an air inlet 108. The compressor 102 raises the pressure of the air and supplies compressed air to both the combustor 104 and, in the depicted embodiment, to a bleed air outlet port 110. In the combustor 104, the compressed air is mixed with fuel that is supplied to the combustor 104 from a non-illustrated fuel source via a plurality of fuel nozzles 112. The fuel/air mixture is combusted, generating high-energy gas, which is then directed into the turbine 106.

The high-energy gas expands through the turbine 106, where it gives up much of its energy and causes the turbine 106 to rotate. The gas is then exhausted from the APU 100 via an exhaust gas outlet 114. As the turbine 106 rotates, it drives, via a turbine shaft 116, various types of equipment that may be mounted in, or coupled to, the APU 100. For example, in the depicted embodiment the turbine 106 drives the compressor 102. It will be appreciated that the turbine 106 may also be used to drive a generator and/or a load compressor and/or other rotational equipment, which are not shown in FIG. 1 for ease of illustration.

As FIG. 1 additionally shows, the compressor inlet 108 is coupled to an air inlet system 118, and the exhaust gas outlet 114 is coupled to an exhaust system 122. The inlet system 118 includes an inlet duct 124 that is coupled between the compressor inlet 108 and a ram air inlet 126 that is formed, for example, through a section of an aircraft fuselage 128. The exhaust system 122 includes an outlet duct 132 and muffler 134. The exhaust duct 132 is coupled between the turbine exhaust gas outlet 114 and an exhaust opening 136 that is also formed, for example, through a section of the aircraft fuselage 128.

An APU inlet door 138 is rotationally mounted adjacent to the ram air inlet 126 and is movable, via an inlet door actuator 142, to a plurality of positions between a closed position and a maximum open position. When the inlet door actuator 142 moves the APU inlet door 138 to the closed position, the inlet door 138 seals the ram air inlet 126, preventing air flow into and through the inlet duct 124 to the APU 100. When the inlet door actuator 142 moves the APU inlet door 138 out of the closed position, ram air may flow through the ram air inlet 126, and into and through the inlet duct 124 to the APU 100. It will be appreciated that the rate at which ram air flows into and through the inlet duct 124 will vary depending on the position to which the inlet door actuator 142 has moved the APU inlet door 138.

The APU 100 is controlled via an electronic control unit 150, which is referred to herein as an APU controller. The APU controller 150 implements various control logic to control the operation of the APU 100. In particular, the APU controller 150, at least in the depicted embodiment, implements fuel control logic 200 and inlet door control logic 300. In the depicted embodiment, the fuel control logic 200 controls fuel flow to the combustor fuel nozzles 112 by controlling the position of a fuel metering valve 144. It will be appreciated that the use of a single fuel metering valve 144 is merely exemplary of the depicted embodiment, and that the fuel control logic 200 could instead, or additionally, control fuel flow by controlling one or more additional valves or pumps. It will additionally be appreciated that the fuel control logic 200 may be implemented according to any one of numerous fuel control logic schemes, now known or developed in the future. A detailed description of the fuel control logic is not needed to enable or fully describe the instant invention, and will thus not be further described.

The inlet door control logic 300 receives a plurality of APU signals 148 and a plurality of aircraft signals 152 and, in response to these signals, supplies APU inlet door position commands 146 to the APU inlet door actuator 142. The inlet door position commands 146 supplied by the inlet door control logic 300 correspond to the minimum APU inlet door position that will maintain the turbine inlet temperature of the APU 100 at a predetermined turbine inlet temperature value. Thus, in a preferred embodiment, the inlet door control logic 300 is additionally configured to calculate the predetermined turbine inlet temperature value. The APU inlet door actuator 142, in response to the APU inlet door position commands 146, moves the APU inlet door 138 to the minimum APU inlet door position.

The APU signals 148 that are supplied to the inlet door control logic 300 are each representative of a sensed APU operational parameter, and each aircraft signal 152 that is supplied to the inlet door control logic 300 is representative of a sensed aircraft operational parameter. It will be appreciated that the particular APU operational parameters and the particular aircraft operational parameters that are used in the inlet door control logic 300 may vary. In the depicted embodiment, however, the APU operational parameters include, but are not limited to, APU inlet temperature, APU inlet pressure, APU rotational speed, APU exhaust gas temperature (EGT), and fuel flow to the APU 100. In some embodiments, the APU operational parameters may also include APU lubricant temperature, if needed or desired. The aircraft operational parameters include, but are not limited to, aircraft speed, ambient temperature outside of the aircraft, and ambient pressure outside of the aircraft.

The specific sources of each of the APU signals and each of the aircraft signals may vary. For example, one or more of the APU and aircraft signals may be supplied to the inlet door control logic 300 directly via sensors or indirectly via other aircraft systems or devices. For example, at least in the depicted embodiment, the APU signals are supplied to the inlet door control logic 300 directly via sensors. Thus, as FIG. 1 additionally depicts, the APU 100 further includes an inlet temperature sensor 154, an inlet pressure sensor 156, a rotational speed sensor 158, an EGT sensor 162, and a fuel flow sensor 164. The inlet temperature sensor 154 is configured to sense the temperature of the air at the compressor inlet 108. The inlet pressure sensor 156 is configured to sense the pressure of the air at the compressor inlet 108. The rotational speed sensor 158 is configured to sense the rotational speed of the APU 100. The EGT sensor 162 is configured to sense exhaust gas temperature, and the fuel flow sensor 164 is configured to sense fuel flow to the combustor 104.

As FIG. 1 additionally depicts, the aircraft signals, at least in the depicted embodiment, are each supplied to the inlet door control logic 300 indirectly via an aircraft avionics system 160. It will be appreciated that the depicted embodiment is merely exemplary, and that other embodiments may have one or more of the APU signals supplied indirectly, and one or more of the aircraft signals supplied directly.

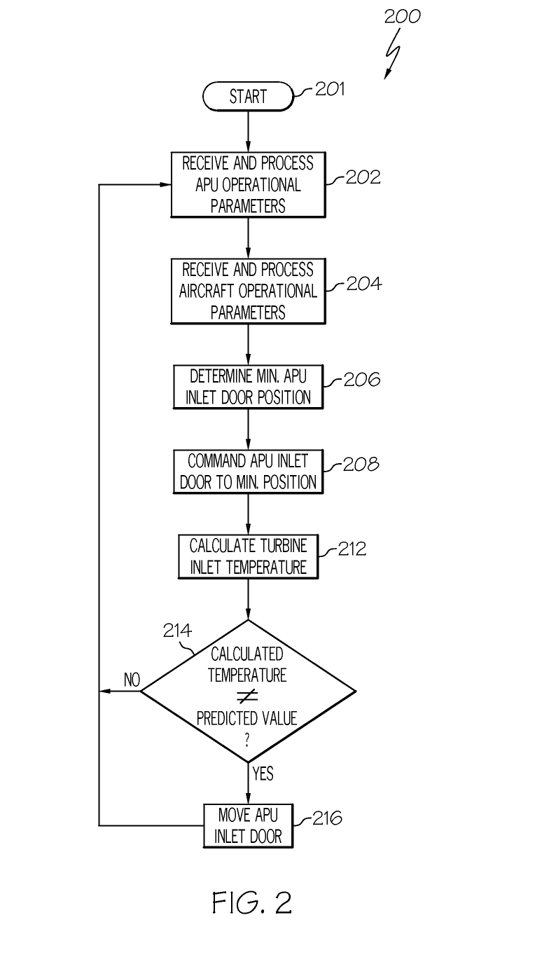

No matter the specific sources of the APU signals and the aircraft signals, the inlet door control logic 300, as was noted above, processes these signals and supplies APU inlet door position commands 146 to the APU inlet door actuator 142. As was also noted above, the APU inlet door position commands 146 correspond to the minimum APU inlet door position that will maintain the turbine inlet temperature of the APU 100 at a predetermined turbine inlet temperature value. With reference now to FIG. 2, one exemplary embodiment of a process 200 that may be implemented by the inlet door control logic 300 to carry out this function is depicted in flowchart form, and will be described.

The inlet door control logic 300, upon initiating the process 200, receives and processes the APU operational parameters (202) and receives and processes the aircraft parameters (204). The inlet door control logic 300, based on the APU and aircraft operational parameters, determines the minimum APU inlet door position that will maintain APU turbine inlet temperature at a predetermined value (206). The inlet door control logic 300 commands the APU inlet door 138 to be moved to the determined minimum APU inlet door position (208).

The inlet door control logic 300, as was also noted above, calculates turbine inlet temperature (212). The inlet door control logic 300 does so using selected ones of the APU operational parameters, and using techniques readily known in the art. The calculated turbine inlet temperature is compared to the predetermined turbine inlet temperature value (214). If the calculated turbine inlet temperature differs from the predetermined value by a predetermined amount, then the inlet door control logic 300 commands the APU inlet door 138 to be moved either to a more open position or a more closed position (216), depending upon whether the calculated turbine inlet temperature was greater than or less than the predetermined value.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The word “exemplary” is used exclusively herein to mean “serving as an example, instance, or illustration.” Any embodiment described herein as “exemplary” is not necessarily to be construed as preferred or advantageous over other embodiments. The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An auxiliary power unit (APU) inlet door control system, comprising:
an APU controller adapted to receive a plurality of APU signals and a plurality of aircraft signals, each APU signal representative of a sensed APU operational parameter, each aircraft signal representative of a sensed aircraft operational parameter, the APU controller configured, in response to the APU signals and the aircraft signals, to (i) determine a minimum APU inlet door position that will maintain APU turbine inlet temperature at a predetermined turbine inlet temperature value and (ii) supply APU inlet door position commands; and
an APU inlet door actuator adapted to couple to an APU inlet door, the APU inlet door actuator coupled to receive the APU inlet door position commands and configured, in response thereto, to move to a position representative of the minimum APU inlet door position.

2. The system of claim 1, wherein the APU controller is further configured, in response to the APU signals and the aircraft signals, to calculate the predetermined turbine inlet temperature value.

3. The system of claim 1, wherein the sensed APU operational parameters include APU inlet temperature, APU inlet pressure, APU rotational speed, APU exhaust gas temperature, and fuel flow to the APU.

4. The system of claim 3, wherein the sensed APU operational parameters further include APU lubricant temperature.

5. The system of claim 1, wherein the sensed aircraft operational parameters include aircraft speed, ambient temperature outside the aircraft, and ambient pressure outside the aircraft.

6. An auxiliary power unit (APU) inlet door control system, comprising:
an APU inlet door movable to a plurality of positions between a closed position and a maximum open position;
an APU controller adapted to receive a plurality of APU signals and a plurality of aircraft signals, each APU signal representative of a sensed APU operational parameter, each aircraft signal representative of a sensed aircraft operational parameter, the APU controller configured, in response to the APU signals and the aircraft signals, to (i) determine a minimum APU inlet door position that will maintain APU turbine inlet temperature at a predetermined value and (ii) supply APU inlet door position commands; and
an actuator coupled to the APU inlet door, the actuator further coupled to receive the APU inlet door position commands and configured, in response thereto, to move the APU inlet door to the minimum APU inlet door position.

7. The system of claim 6, wherein the APU controller is further configured, in response to the APU signals and the aircraft signals, to calculate the predetermined turbine inlet temperature value.

8. The system of claim 6, wherein the sensed APU operational parameters include APU inlet temperature, APU inlet pressure, APU rotational speed, APU exhaust gas temperature, and fuel flow to the APU.

9. The system of claim 8, wherein the sensed APU operational parameters further include APU lubricant temperature.

10. The system of claim 6, wherein the sensed aircraft operational parameters include aircraft speed, ambient temperature outside the aircraft, and ambient pressure outside the aircraft.

11. A method of controlling an auxiliary power unit (APU) inlet door, comprising the steps of:
sensing a plurality of APU operational parameters;
sensing a plurality of aircraft operational parameters;
processing the APU operational parameters and the aircraft operational parameters to determine a minimum APU inlet door position that will maintain APU turbine inlet temperature at a predetermined value; and
moving the APU inlet door to the determined minimum APU inlet door position.

12. The method of claim 11, further comprising calculating the predetermined turbine inlet temperature value.

13. The method of claim 11, wherein the sensed APU operational parameters include APU inlet temperature, APU inlet pressure, APU rotational speed, APU exhaust gas temperature, and fuel flow to the APU.

14. The method of claim 13, wherein the sensed APU operational parameters further include APU lubricant temperature.

15. The method of claim 11, wherein the sensed aircraft operational parameters include aircraft speed, ambient temperature outside the aircraft, and ambient pressure outside the aircraft.
